(19) United States
(12) Patent Application Publication
(10) Pub. No.: US 2015/0089288 A1
(43) Pub. Date: Mar. 26, 2015

(54) TECHNIQUE FOR ESTABLISHING AN AUDIO SOCKET DEBUG CONNECTION

(71) Applicant: NVIDIA CORPORATION, Santa Clara, CA (US)

(72) Inventor: Mark A. OVERBY, Bothell, WA (US)

(73) Assignee: NVIDIA CORPORATION, Santa Clara, CA (US)

(21) Appl. No.: 14/034,388

(22) Filed: Sep. 23, 2013

(51) Int. Cl. G06F 11/27

(52) U.S. Cl. CPC G06F 11/27
USPC 714/30

(57) ABSTRACT

A debug controller monitors a tip-ring-ring-shield (TRRS) socket, within a form factor device, to detect whether a debug unit is transmitting a request for a TRRS socket debug connection. The form factor device also includes a system on chip (SoC), a switch, and an audio codec. The SoC includes the debug controller and a software debug interface. The switch couples a right audio lead and left audio lead of the TRRS socket to the audio codec. If the debug controller detects the request from the debug unit, then the debug controller instructs the switch to establish a TRRS socket debug connection. The switch establishes the TRRS socket debug connection by coupling right audio lead and left audio lead to the software debug interface instead of the audio codec. This establishment of the TRRS socket debug connection eliminates the need for manual configuration of the TRRS socket debug connection.

### BACKGROUND OF THE INVENTION

1. Field of the Invention

Embodiments of the invention generally relate to software debugging and, more specifically, to a technique for establishing an audio socket debug connection.

2. Description of the Related Art

Software developers oftentimes rely upon debug ports to debug both application and kernel level software executing on devices within a production form factor. Debug ports allow a software developer to monitor the state of the application and/or device as software executes on the device. Traditional computer systems, such as personal computers, have multiple serial ports or expansion ports that allow for software debugging. The software developer may also debug software by connecting a debug cable to a universal serial bus (USB) port of a personal computer.

Although circuit boards of portable devices may include software debug ports, form factor portable devices oftentimes do not expose serial or expansion ports for software debugging. Some existing portable devices attempt to provide a software debug port by co-opting an audio socket, such as a tip-ring-ring-shield (TRRS) socket, to provide a software debug connection. A TRRS socket normally operates as an audio connection for coupling external audio devices, such as headphones, to the circuit board of the portable device. Switching the TRRS socket to operate as a debug connection typically requires a software developer to manually input complex instructions, boot into debug modes, and/or physically manipulate the portable device. These steps can be error-prone, time-consuming, and difficult.

As the foregoing illustrates, what is needed in the art is an improved technique for establishing a debug connection.

### SUMMARY OF THE INVENTION

One embodiment of the present invention sets forth a method for performing a debugging operation. The method includes determining that a cable has been inserted into a first socket of a hand-held device, detecting that a start pattern has been transmitted, coupling the first socket to a debug interface, and performing the debugging operation.

One advantage of the disclosed technique is that a software developer may begin debugging software executing within a portable device by simply inserting a debug cable into the portable device. Accordingly, the complex, difficult, and error-prone debug process associated with prior art techniques can be avoided.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a portable device configured to automatically detect a debug cable and establish a TRRS socket debug connection with a debug utility coupled to the debug cable, according to one embodiment of the present invention; and

FIG. 3 is a flow diagram of method steps for detecting and switching to the TRRS socket debug connection to enable a debugging operation to occur, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

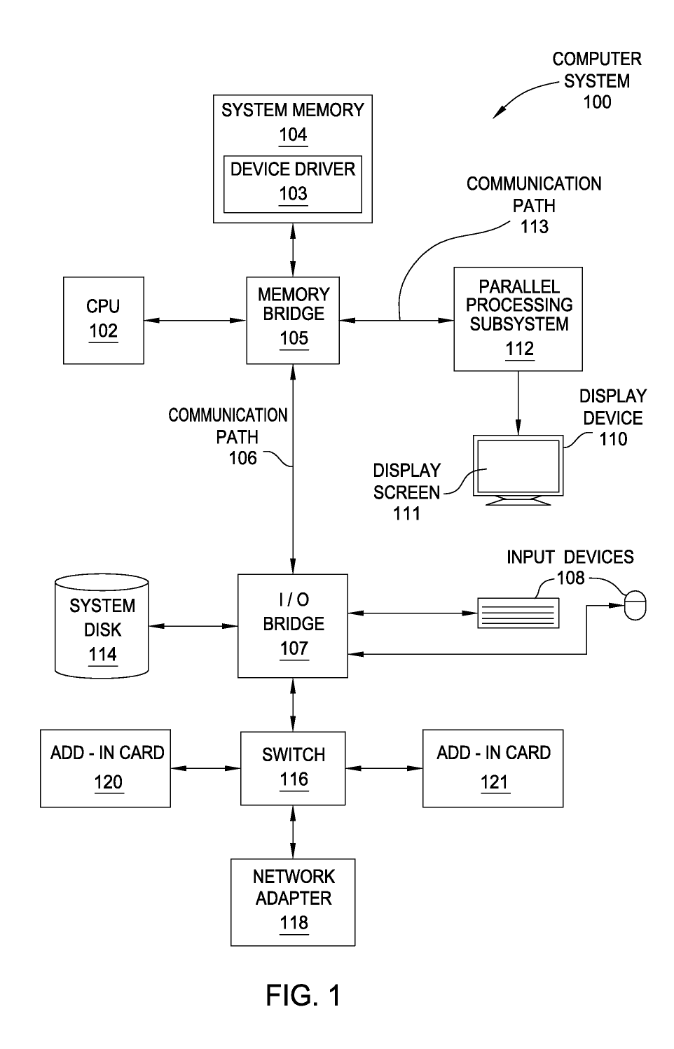

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. This circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

### Establishing an Audio Socket Debug Connection

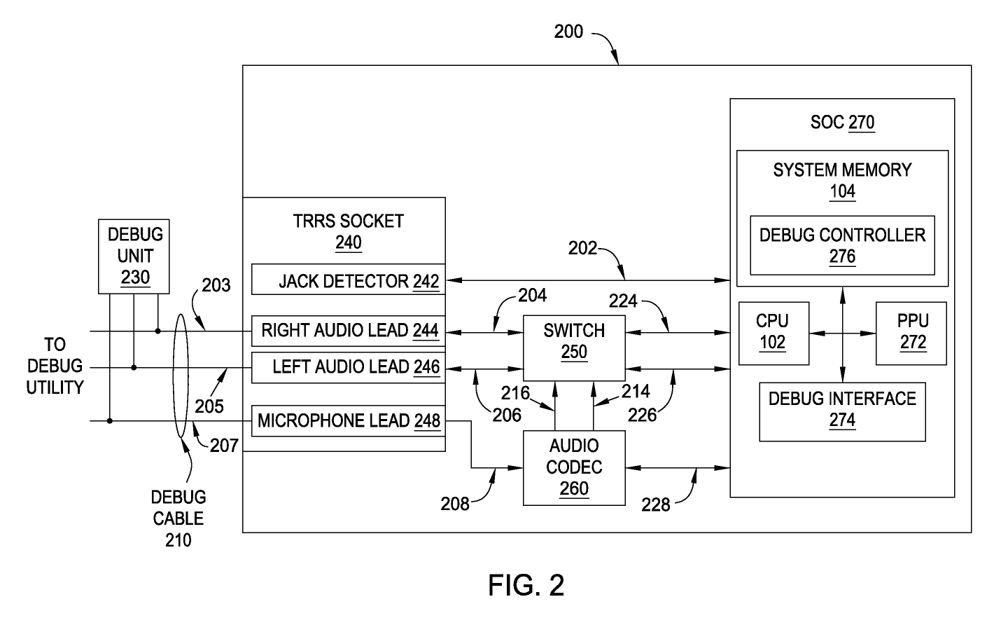

FIG. 2 is a block diagram of a portable device 200 configured to automatically detect a debug cable 210 and establish a TRRS socket debug connection with a debug utility coupled to the debug cable 210, according to one embodiment of the present invention. The portable device 200 may be a mobile device, such as a cellular phone, a tablet computer, or a laptop. The portable device 200 may include some of the same elements of the computer system 100 shown in FIG. 1. The portable device 200 is configured to operate according to different modes of operation when different types of cables are coupled to the portable device 200.

In particular, when an audio cable is coupled to the portable device 200, the portable device 200 operates according to a default mode of operation. In the default mode, the portable device 200 may output audio signals along the audio cable, including, e.g. music. The portable device 200 may also receive input signals along the audio cable when operating in the default mode, including, e.g., audio recordings received from a microphone.

Alternatively, when the debug cable 210 is coupled to the portable device 200, as is shown, the portable device 200 operates according to a debug mode. Upon entering the debug mode, the portable device 200 is configured to establish a TRRS socket debug connection with a debug utility coupled to the debug cable 210. The TRRS socket debug connection allows a software developer to debug software executing on the portable device 200 by interacting with the debug utility. The debug utility could be, for example, a debug application executing on a personal computer. The software developer uses the debug utility to perform software debugging tasks, such as transmitting software debugging data to and receiving software debugging data from the portable device 200 across the debug cable 210. The software debugging data may include information about the state of an application executing on the portable device 200 or instructions for the application.

The portable device 200 is configured to operate in the default mode until the debug cable 210 is coupled to the portable device 200. Specifically, when an audio cable is coupled to the portable device 200, or when no cable at all is coupled to the portable device 200, the portable device 200 operates in the default mode. However, when the debug cable 210 is coupled to the portable device 200, the portable device 200 then switches from the default mode to the debug mode. When the debug cable is removed from the portable device 200, the portable device 200 then returns to the default mode. The debug cable 210 includes circuitry configured to interoperate with hardware and software elements within the portable device 200 in order to establish the TRRS socket debug connection, as described in greater detail below.

As shown, the debug cable 210 includes various connectors. The connectors could be, e.g., wires coupled to a TRRS plug that transport electric signals. The software developer may couple the debug cable 210 to the portable device 200 by inserting the TRRS plug of the debug cable 210 into a TRRS socket 240 included in the portable device 200. The connectors 203 and 205 are configured to transport the software debugging data.

The debug cable 210 includes a debug unit 230. The debug unit 230 is configured to instruct the portable device 200 to switch to the debug mode of operation when the debug cable 210 is coupled to the TRRS socket 240. The debug unit 230 requests that the portable device 200 switch to the debug mode of operation by transmitting a start pattern to the portable device 200, via connector 207.

The portable device 200 includes various connectors, the TRRS socket 240, an SoC 270, an audio codec 260, and a switch 250. The TRRS socket 240, the SoC 270, the audio codec 260, and the switch 250 may be mounted onto a printed circuit board (PCB). The portable device 200 is a form factor device within a case. The case surrounds the various connectors, the TRRS socket 240, the SoC 270, the audio codec 260, and the switch 250.

The TRRS socket 240 is a cable jack accessible from outside the form factor of the portable device 200. The TRRS socket 240 includes a jack detector 242, a right audio lead 244, a left audio lead 246, and a microphone lead 248. The jack detector 242 is coupled to the SoC 270 by a connector 202. The right audio lead 244 is coupled to the switch 250 by a connector 204, the left audio lead 246 is coupled to the switch 250 by connector 206, and the microphone lead 248 is coupled to the audio codec 260 by connector 208, as is shown.

As also shown, the switch 250 is coupled to SoC 270 by connectors 214 and 216. The switch 250 may also be coupled to the audio codec by connectors 224 and 216. The audio codec is coupled to the SoC 270 by connector 228. The various connectors 202, 204, 206, 208, 214, 216, 224, 226, and 228 may be wires or traces across the PCB that transport electric signals.

The TRRS socket 240 is located along the edge of the portable device 200, so that the software developer can insert the debug cable 210 into the TRRS socket 240. The jack detector 242 is configured to detect if a TRRS plug is present within the TRRS socket 240. The jack detector 242 may include circuitry that transmits a high voltage when a TRRS plug is not present and a low voltage when a TRRS plug is present. The connector 202 transports the high voltage or low voltage to the SoC 270.

When the debug cable 210 is inserted into the TRRS socket 240, then connector 207 couples with the microphone lead 248, connector 203 couples with the right audio lead 244, and connector 205 couples with the left audio lead 246. The debug unit 230 then transmits the start pattern to the audio codec 260, via the connector 207, the microphone lead 248, and the connector 208. The software debugging data flows from the debug utility to the switch 250, via the connector 203, the right audio lead 244, and the connector 204. The software debugging data also flows from the switch 250 to the debug utility, via the connector 206, the left audio lead 246, and the connector 205.

The SoC 270 is configured to execute application and kernel level software. For instance, if the portable device 200 is a cellular telephone, then the SoC 270 could be configured to execute phone, short messaging service (SMS), and notification applications. The SoC 270 could also process email, perform web browsing, and execute user applications in response to input from a user. The SoC 270 may include similar elements to computer system 100. As shown, the SoC 270 includes a debug interface 274, the CPU 102, a PPU 272 within the parallel processing subsystem 112 of FIG. 1, and the system memory 104, which are coupled together. The debug interface 274 may be a universal asynchronous receiver/transmitter (UART) configured to transmit signals across connector 224 and receive signals across connector 226. As discussed above, the CPU 102 may be any technically feasible unit capable of processing data and/or executing software applications. The PPU 272 may operate as a graphics processor or may be used for general-purpose computation.

The CPU 102 and PPU 272 are configured to read data from and write data to the system memory 104. The system memory 104 may include a random access memory (RAM) module, a flash memory unit, or any other type of memory unit or combination thereof. The system memory 104 includes a debug controller 276. The debug controller 276 is a software application that, when executed by CPU 102, provides software debugging services. Those software debugging services include monitoring the TRRS socket 240 and switching the portable device 200 to the debug mode. Switching to the debug mode includes establishing the TRRS socket debug connection, as described in greater detail below.

The audio codec 260 is configured to convert analog input to digital output and digital input to analog output. The audio codec 260 receives analog input from the microphone lead 248 via connector 208. The audio codec 260 converts the analog input from the microphone lead 248 into digital input. The audio codec 260 transmits the digital input to the SoC 270 via connector 228.

The audio codec 260 receives digital output from the SoC 270. The audio codec 260 converts the digital output from the SoC 270 into analog output. The audio codec 260 transmits the analog output to the switch 250. Connectors 214 and 216 transport the analog output from the audio codec 260 to the switch 250.

The switch 250 is configured to route analog output received from the audio codec 260 to the TRRS socket 240 in the default mode of operation. The switch 250 may be a multiplexer. The switch 250 couples the right audio lead 244 and the left audio lead 246 to the audio codec 260. Analog output flows from the audio codec 260, through the switch 250, and to the right audio lead 244 and the left audio lead 246.

The switch 250 is also configured to couple the right audio lead 224 and the left audio lead 246 to the debug interface 274 instead of to the audio codec 260. When the portable device 200 changes to the debug mode, the switch 250 establishes the TRRS socket debug connection, by coupling the right audio lead 224 and the left audio lead 246 to the debug interface 274. The switch couples the right audio lead 224 and the left audio lead 246 to the debug interface 274, by coupling the connector 204 to the connector 224 and the connector 206 to the connector 226. The switch 250 couples the connector 204 to the connector 224, in place of the connector 214. The switch 250 couples the connector 204 to the connector 224, in place of the connector 214. With the TRRS socket debug connection established, debugging data flows between the debug interface 274 and the right audio lead 244 and the left audio lead 246 of TRRS socket 240.

As discussed, the debug controller 276 is configured to control whether the portable device 200 operates in the default mode or the debug mode. In order to control whether the portable device 200 operates in the default mode or the debug mode, the debug controller 276 controls when the switch 250 establishes the TRRS socket debug connection. The debug controller 276 may control the switch 250 via an additional connector between the switch 250 and the SoC 270 (not shown). To establish the TRRS socket debug connection, the debug controller 276 instructs the switch 250 to couple the right audio lead 244 and left audio lead 246 to the debug interface 274.

The debug controller 276 is also configured to detect the start pattern from the debug unit 230. The debug controller 276 interprets the start pattern as a request for the portable device 200 to switch to the debug mode and establish the TRRS socket debug connection, as discussed in detail below.

For example, the software developer could use the debug cable 210 to debug an email application executing within the SoC 270. The software developer would plug the debug cable 210 into a TRRS socket 240. The debug unit 230 would transmit the start pattern to request that the portable device 200 switch to the debug mode. In response, the debug controller 276 would instruct the switch 250 to establish the TRRS socket debug connection. The switch 250 couples the connector 204 to the connector 224, in place of the connector 214, and couples the connector 206 to the connector 226, in place of the connector 216. The debug cable 210 and the TRRS socket debug connection would couple the debug utility to the debug interface 274 of the SoC 270. Using the debug utility, the software developer could transmit instructions to start or stop the execution of the email application. The debug utility could also receive information about the state of the email application from the debug controller 276, such as the current value of various variables.

In operation, the software developer inserts the TRRS plug of the debug cable 210 into the TRRS socket 240. As discussed, the jack detector 242 transmits a high voltage when a TRRS plug is not present in the TRRS socket 240 and a low voltage when a TRRS plug is present. The connector 202 transports the high or low voltage to a general purpose I/O (GPIO) of the SoC 270. The debug controller 276 monitors the GPIO to detect a change in the voltage at the GPIO. As the software developer inserts the TRRS plug into the TRRS socket 240, the jack detector 242 changes from transmitting a high voltage to transmitting a low voltage. If the debug controller 276 detects the change in voltage at the GPIO, then the debug controller 276 determines that the debug cable 210 is coupled to the portable device 200.

Once the debug controller 276 determines that the debug cable 210 is coupled to the portable device 200, the debug controller 276 begins listening for a start pattern. The debug unit 230 transmits the start pattern through the connector 207 to the microphone lead 248. The debug unit 230 transmits the start pattern as analog input. The debug unit 230 encodes the start pattern as a non-return-to-zero space (NRZ-S) encoding, where each level of voltage represents either a binary 1 or 0.

The start pattern flows through the microphone lead 248 and connector 208 to the audio codec 260. The audio codec 260 translates analog input below a threshold voltage as a 0, and an analog input above the threshold voltage as a 1. The audio codec 260 translates the NRZ-S encoded start pattern to a series of binary 1s and 0s.

The start pattern may include analog input below the threshold voltage for 100 ms after the user couples the debug cable 210 to the portable device 200. The debug unit 230 follows the 100 ms of analog input below the threshold voltage with a series of analog input above the threshold voltage. The audio codec 260 may translate the analog input of the start pattern to the binary pattern 01111111. The audio codec 260 transmits the binary version of the start pattern to the SoC 270, where the debug controller 276 is listening. Upon detecting the start pattern, the debug controller 276 determines that the debug unit 320 is requesting that the portable device 200 switch to the debug mode and establish the TRRS socket debug connection. The 100 ms of analog input below the threshold voltage provides time for the debug controller 276 to begin listening for the start pattern. However, the cable may repeat the start pattern to ensure that the debug controller 276 receives the start pattern. Persons skilled in the art will recognize that many technically feasible techniques exist for transmitting and detecting a start pattern.

Upon determining that the debug unit 230 is requesting that the portable device 200 switch to the debug mode, the debug controller 276 instructs the switch 250 to establish the TRRS socket debug connection. The switch 250 couples connector 204 to connector 224, in place of connector 214, and couples connector 206 to connector 226, in place of connector 216. Thus, the switch 250 establishes the TRRS socket debug connection, by coupling the debug interface 274 to the right audio lead 244 and left audio lead 246 of the TRRS socket 240. Together the debug cable 210 and the TRRS socket debug connection couple the debug utility to the debug interface 274 of the SoC 270. Thus, the portable device 200 switches to the debug mode and the TRRS socket debug connection provides the debug utility access to the debug interface 274 for software debugging.

The software developer then uses the debug utility to perform software debugging of software executing within the SoC 270. The debug controller 276 provides software debugging services, such as transmitting information about the state of an application and/or the portable device 200 to the debug utility. The debug controller 276 may also start or stop the execution of the application, in response to instructions from the debug utility.

While the TRRS socket debug connection is established, the debug controller 276 monitors the GPIO coupled to jack detector 242. After performing the software debugging, the software developer decouples the debug cable 210 from the portable device 200. As the software developer removes the TRRS plug of the debug cable 210 from the TRRS socket 240, the jack detector 242 switches from transmitting a low voltage to transmitting a high voltage. The connector 202 transports the change in voltage to the GPIO of the SoC 270. In response to detecting the change in voltage at the GPIO, the debug controller 276 instructs the switch 250 to return to the default mode of operation. The switch 250 returns to coupling the connector 204 to the connector 214, in place of connector 224, and the connector 206 to the connector 216, in place of connector 226. By re-coupling the connector 204 to the connector 214 and connector 206 to the connector 216, the switch 250 re-couples the right audio lead 244 and left audio lead 246 to the audio codec 260 and returns to the default mode of operation.

The embodiment illustrated in FIG. 2 is illustrative only and in no way limits the scope of the present invention. In other embodiments, various modifications of the features and functions of the TRRS socket 240, switch 250, audio codec 260, debug controller 276, and debug interface 274 are contemplated. For example, in other embodiments, the SOC 270 may include the audio codec 260 and/or switch 250. In other embodiments, upon establishing the TRRS socket debug connection, the debug controller 276 may mute the input that the microphone lead 248 receives. Further, in still other embodiments, additional patterns that indicate characteristics of the debug cable may follow the start pattern. These characteristics may include the type of communication protocol used by the debug cable or the type of cable.

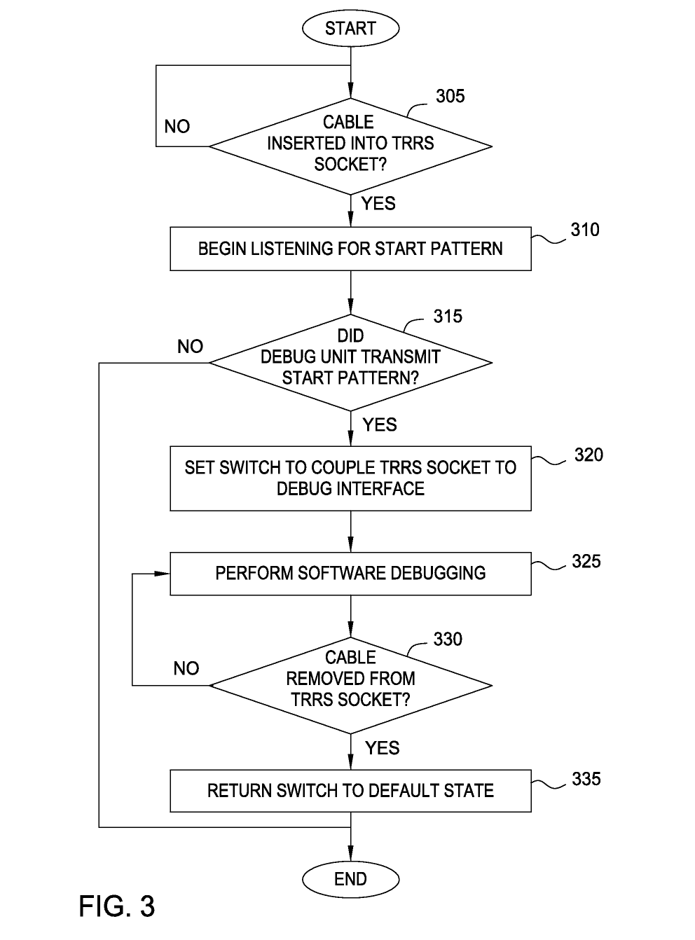

FIG. 3 is a flow diagram of method steps for detecting and switching to the TRRS socket debug connection to enable a debugging operation to occur, according to one embodiment of the present invention. Although the method steps are described in conjunction with the systems of FIGS. 1-2, persons skilled in the art will understand that any system configured to perform the method steps, in any order, is within the scope of the present invention.

As shown, a method 300 begins at step 305, where the debug controller 276 within the portable device 200 determines if a cable has been inserted into the TRRS socket 240. The debug controller 276 detects the cable by monitoring a GPIO of the SOC 270. The GPIO is coupled to the jack detector 242 via connector 202. If the software developer inserts a cable into the TRRS socket 240, the jack detector 242 changes from transmitting a high voltage to transmitting a low voltage. If the debug controller 276 does not detect the change in voltage at the GPIO, then the debug controller 276 determines that a cable has not been inserted into the TRRS socket 240 and the method 300 repeats the step 305. Otherwise, if the debug controller 276 detects the change in voltage at the GPIO, then the debug controller 276 determines that a cable has been inserted into the TRRS socket 240 and the method 300 then proceeds to step 310.

At step 310, the debug controller 276 begins listening for a start pattern from the debug unit 230. The debug unit 230 may transmit the start pattern as analog input below a threshold voltage for 100 ms followed by a series of analog input above the threshold voltage. The debug unit 230 transmits the start pattern to the audio codec 260, through the connector 207, the microphone lead 248, and the connector 208. The audio codec 260 may translate the analog input of the start pattern to the binary pattern 01111111. The audio codec 260 transmits the binary version of the start pattern to the SoC 270, where the debug controller 276 is listening. The 100 ms of analog input below the threshold voltage provides time for the debug controller 276 to begin listening for the start pattern. The method 300 then proceeds to step 315.

At step 315, the debug controller 276 determines if the debug unit 230 transmitted the start pattern. If the debug controller 276 does not detect the binary pattern 01111111 after a 100 ms pause, then the debug controller 276 determines that the debug unit 230 has not transmitted the start pattern and the method 300 then ends. Otherwise, if the debug controller 276 detects the binary pattern 01111111 after a 100 ms pause, then the debug controller 276 determines that the debug unit 230 is requesting that the portable device 200 switch to debug mode by transmitting the start pattern. The debug controller 276 also determines that the cable is the debug cable 210. The method 300 then proceeds to step 320.

At step 320, the debug controller 276 sets the switch 250 to couple the TRRS socket 240 to the debug interface 274. In response, the switch 250 establishes the TRRS socket debug connection by coupling the connector 204 to the connector 224 and the connector 206 to the connector 226. With the connectors 204 and 206 coupled to connectors 224 and 226, software debugging data flows between the debug interface 274 and the right audio lead 244 and left audio lead 246 of the TRRS socket 240. The method 300 then proceeds to step 325.

At step 325, the debug controller 276 performs software debugging. The debug controller 276 provides software debugging services to the debug utility, via the cable and the TRRS socket debug interface. The software debugging services may include transmitting the state of an application and/or the portable device 200 to the debug utility. The debug controller 276 may also control the execution of the application based upon input received from the debug utility. The method 300 then proceeds to step 330.

At step 330, the debug controller 276 determines if the cable has been removed from the TRRS socket 240. As the software developer removes the TRRS plug of the debug cable 210 from the TRRS socket 240, the jack detector 242 switches from transmitting a low voltage to transmitting a high voltage. The connector 202 transports the change in voltage to the GPIO of the SoC 270. If the debug controller 276 does not detect the change in voltage at the GPIO, then the debug controller 276 determines that the cable has not been removed from the TRRS socket 240 and the method 300 returns to the step 325. Otherwise, if the debug controller 276 detects the change in voltage at the GPIO, then the debug controller 276 determines that the cable has been removed from the TRRS socket 240 and the method 300 then proceeds to step 335.

At step 335, the debug controller 276 returns the switch 250 to the default state. The switch 250 again couples connector 204 to the connector 214 and the connector 206 to the connector 216, which re-couples the right audio lead 244 and left audio lead 246 to the audio codec 260. The method 300 then ends.

In sum, the techniques disclosed above provide the establishment of a TRRS socket debug connection within a portable device. The portable device includes a switch, an audio codec, and a SoC with a debug interface and debug controller. In a default mode of operation, the switch couples the right audio lead and left audio lead of the TRRS socket to the audio codec. A debug cable is coupled to a debug unit. When a software developer inserts the debug cable into the TRRS socket the debug unit transmits a start pattern to request that the portable device switch from the default mode to a debug mode. Switching to the debug mode includes establishing the TRRS socket debug connection. Upon detecting the start pattern, the debug controller establishes the TRRS socket debug connection. To establish the TRRS socket debug connection, the debug controller instructs the switch to couple the right audio lead and left audio lead to the software debug interface of the SoC.

Advantageously, a software developer can begin debugging software executing within a portable device without first performing a complex, difficult, and error-prone process to establish the TRRS socket debug connection. The automatic detection of a request for the TRRS socket debug connection and connection of the right audio lead and left audio lead of the TRRS socket to the software debug interface can eliminate the need for manual configuration of the TRRS socket debug connection.

While the foregoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of the present invention is determined by the claims that follow.

What is claimed is:

1. A computer-implemented method for performing a debugging operation, the method comprising:
determining that a cable has been inserted into a first socket of a hand-held device;
detecting that a start pattern has been transmitted;
coupling the first socket to a debug interface; and
performing the debugging operation.

2. The method of claim 1, wherein the first socket comprises a tip-ring-ring-shield socket.

3. The method of claim 2, wherein coupling comprises setting a switch to couple the tip-ring-ring-shield socket to the debug interface.

4. The method of claim 3, further comprising determining whether the cable has been removed from the tip-ring-shield-socket.

5. The method of claim 4, wherein the cable has been removed from the tip-ring-shield-socket, and further comprising causing the switch to return to default state.

6. The method of claim 4, wherein the cable has not been removed from the tip-ring-shield-socket, and further comprising continuing the debugging operation.

7. The method of claim 1, further comprising listening for the start pattern.

8. The method of claim 1, wherein determining comprises detecting a change to a high voltage at a general purpose input/output location.

9. A non-transitory computer-readable medium including instructions that, when executed by a processing unit, cause the processing unit to perform a debugging operation, by performing the steps of:
determining that a cable has been inserted into a first socket of a hand-held device;
detecting that a start pattern has been transmitted;
coupling the first socket to a debug interface; and
performing the debugging operation.

10. The computer-readable medium of claim 9, wherein the first socket comprises a tip-ring-ring-shield socket.

11. The computer-readable medium of claim 10, wherein coupling comprises setting a switch to couple the tip-ring-ring-shield socket to the debug interface.

12. The computer-readable medium of claim 11, further comprising determining whether the cable has been removed from the tip-ring-shield-socket.

13. The computer-readable medium of claim 12, wherein the cable has been removed from the tip-ring-shield-socket, and further comprising causing the switch to return to default state.

14. The computer-readable medium of claim 12, wherein the cable has not been removed from the tip-ring-shield-socket, and further comprising continuing the debugging operation.

15. The computer-readable medium of claim 9, further comprising listening for the start pattern.

16. The computer-readable medium of claim 9, wherein determining comprises detecting a change to a high voltage at a general purpose input/output location.

17. A computing device, comprising:
a processing unit configured to execute a debug controller;
a socket configured to receive a cable; and
a switch that couples the socket to the processing unit,
wherein, when executed, the debug controller:
determines that the cable has been inserted into the socket,
detects that a start pattern has been transmitted,
sets the switch to couple the socket to a debug interface; and
performs a debugging operation.

18. The computing device of claim 17, wherein the socket comprises a tip-ring-ring-shield socket.

19. The computing device of claim 18, wherein the processing unit is included within a system-on-chip (SoC).

20. The computing device of claim 19, wherein the debug controller determines that the cable has been inserted into the tip-ring-ring-shield socket by detecting a change to a high voltage at a general purpose input/output of the SoC.
